(19) United States
(12) Patent Application Publication
(10) Pub. No.: US 2009/0159759 A1
(43) Pub. Date: Jun. 25, 2009

(54) Fixing device, in particular for pipelines in flue gas absorbers

(75) Inventor: Rainer Ansperger, Gladbeck (DE)

Correspondence Address: HARNESS, DICKEY & PIERCE, P.L.C., P.O. BOX 828, BLOOMFIELD HILLS, MI, 48303, US

(73) Assignee: AE & E Lentjes GmbH

(21) Appl. No.: 12/317,049

(22) Filed: Dec. 18, 2008

(30) Foreign Application Priority Data
Dec. 21, 2007 (DE) 10 2007 062 855.4

(51) Int. Cl. F16L 3/24

(52) U.S. Cl. 248/72

(57) ABSTRACT

The present invention relates to a device for fixing a tube (1) on a holding beam (2), in particular in units for flue gas purification. According to the invention it is provided that the tubes (1) to be fixed are put on a pipe hanger (3) and fixed on the pipe hanger (3) by means of pipe clips (5) that engage in appropriate holding plates (4) and are thus firmly connected to the holding beam (2).

### BACKGROUND OF THE INVENTION

1. Technical Field

The present invention relates to a device for fixing a tube on a holding beam, in particular for fixing pipelines inside absorbers of flue gas purification units.

2. Discusssion

For fixing pipelines in absorbers of flue gas purification units, these ones are usually fixed on holding beams by means of semicircular pipe clips, wherein the pipe clips are connected to the holding beams carrying the pipeline by means of appropriate threaded sections. For this, the holding beams comprise corresponding through holes or receivers for the threaded sections of the pipe clips, via which the pipe clips can then be connected to the holding beam by means of screwing.

By such a fixation, pipelines can be safely fixed on holding beams. However, in the area of aggressive and in particular corrosive media, the corresponding fixing devices have to be protected against a corrosive attack or they have to be made of a corrosion resistant material. Herein, it has however to be observed that due to the type of fixation via corresponding screw connections the used materials have to comprise a sufficient tension load carrying ability in order to assure a safe fixation of the pipelines on corresponding holding beams. Therefore, holding beams are often made of stainless steel, such as for example C276/2.4859 or Hastelloy. However, these materials are usually extremely expensive and are often subject to strong price variations, such that in the planning of installations a safe price calculation is often not possible for making an offer.

Furthermore, the conventional materials usually have to be additionally coated with a rubber film on site, i.e. at the place of the final assembly. Herein, all bores also have to be coated with rubber and it has to be taken care that the rubber film is continuously tight in order to assure a sufficient protection against corrosion which is important in the media conditions of flue gas purification units.

Thus, the mounting of corresponding tube fixations in flue gas purification units usually requires extremely high efforts and has to be carried out with greatest accuracy in order to avoid untimely corrosive damages in the flue gas purification units.

### SUMMARY OF THE INVENTION

In consideration of the above statements it is the object of the present invention to provide a device for fixing a tube on a holding beam, which device can be manufactured at low costs and can be easily mounted.

This aim is achieved by a device for fixing a tube on a holding beam, wherein the device comprises a pipe hanger, a holding plate as well as a pipe clip, wherein the holding plate is connected to the holding beam and the pipe hanger comprises lateral guide elements that are formed such that the pipe hanger engages in a precisely fitting way into the holding plate connected to the holding beam, wherein the holding plate comprises fixation portions projecting over the pipe hanger, which fixation portions can engage in fixation grooves in the pipe clip for fastening the tube, and wherein the pipe clip, in the fixation state, embraces both the tube and the pipe hanger in a precisely fitting way and can be firmly connected to the pipe hanger via fixation means.

A locking pin can serve as fixation means for connecting the pipe clip to the pipe hanger, which locking pin can be inserted into the pipe hanger via a locking pin receiver in the pipe clip.

Alternatively, it can be provided according to the invention that a weld between the pipe clip and the pipe hanger serves as fixation means for connecting the pipe clip to the pipe hanger, which weld connects the pipe clip to the pipe hanger in the fastened state.

In one embodiment of the invention, the pipe hanger and the pipe clip can be made of a synthetic material, such as for example polypropylene or a glass fiber reinforced synthetic material, since the corresponding elements are only submitted to small tension loads and thus they can assure a safe and permanent fixation of the tube on the holding beam. In another embodiment it can be provided that both the pipe hanger and the pipe clip comprise a steel core that is coated with a corresponding synthetic material for forming a pipe hanger or a pipe clip. Such elements can be easily manufactured by means of modern plastic injection moulding techniques.

The holding plate (4) provided according to the invention can be connected to the holding beam (2) by means of a weld. The correspondingly connected holding plates (4) and holding beams (2) can afterwards be easily protected against corrosive attacks by applying corresponding corrosion preventives, such as rubber films. Thanks to this embodiment one can omit through holes through holding beams or carrier elements which are clearly more difficult to coat with rubber films due to the through holes or which often suffer damages of the corrosion protection in the area of the through holes during the assembly.

### BRIEF DESCRIPTION OF THE DRAWINGS

FIGS. 1 through 4 illustrate the fastening principle of pipelines by means of the fixing device according to the invention.

FIG. 1 shows an explosion drawing of the fixing device according to the invention.

FIG. 2 shows the first assembling steps for fastening a tube by means of the fixing device according to the invention.

FIG. 3 shows the course of the progressing assembly of the fixing device according to the invention.

FIG. 4 shows a tube fixed on a holding beam by means of the fixing device according to the invention.

### DESCRIPTION OF THE PREFERRED EMBODIMENTS

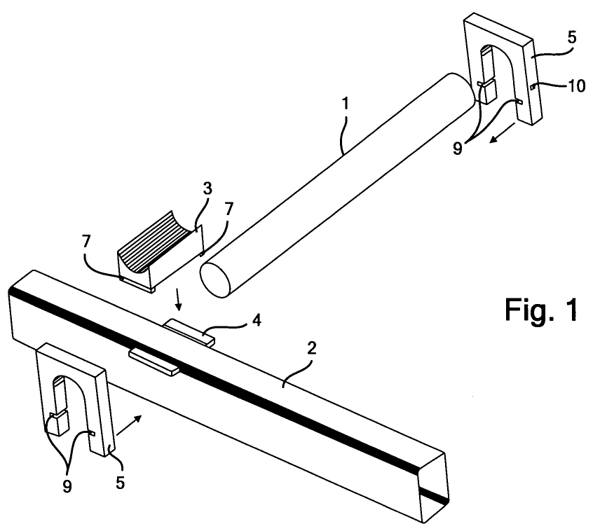

In FIG. 1 the holding plates 4 have been fixed on the holding beam 2 by means of a weld. A continuous rubber film has been applied on the holding beam 2 as well as the holding plates 4 for protecting them against corrosion. The pipe hanger 3 comprises guide elements 7 in the end portions of the longitudinal extension, which guide elements enable the pipe hanger 3 to be put in a precisely fitting way on the holding beam 2 and the holding plates 4.

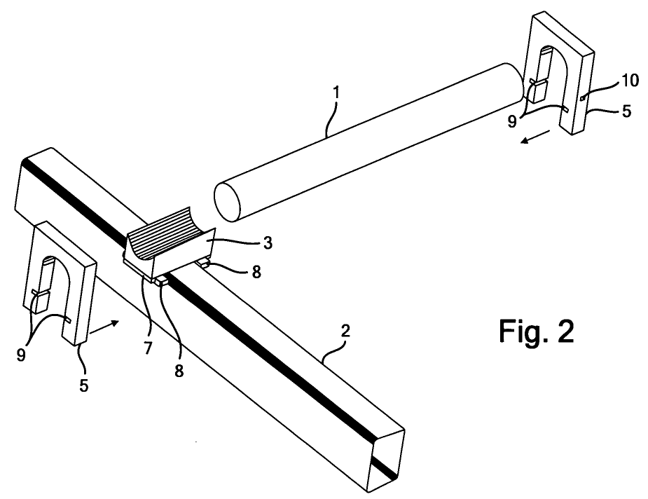

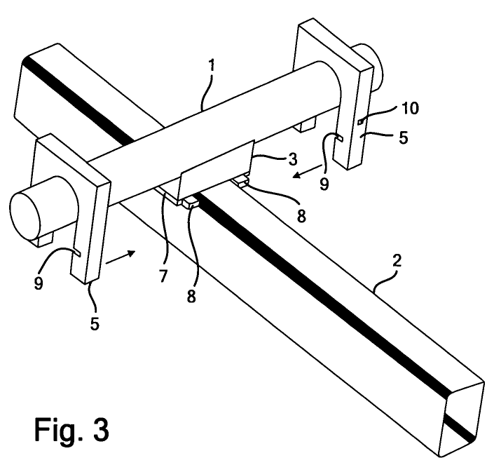

In FIG. 2 the pipe hanger 3 has been put onto the holding beam 2 and the holding plates 4. According to the invention, the holding plates 4 are longer than the width of the pipe hanger 3, such that the holding plates 4 project over the pipe hanger 3 and form fixation portions 8.

The pipe clips 5, which comprise fixation grooves 9 that correspond to the fixation portions 8 of the holding plates 4, are now laterally slid in a simple way onto the pipe hanger 3 over the tube 1, such that the fixation grooves 9 engage into the fixation portions 8 of the holding plates 4. Thus, the tube 1 can be fixed in a simple manner on the holding beam 2. In an alternative embodiment of the invention, the pipe clips 5 do not have to be laterally slid onto the pipe hanger 3 and the fixation portions 8 of the holding plates 4, but the pipe clips 5 are elastic and can be slipped on the pipe hanger 3 and the holding plates 4 from above in that its legs are slightly bent outwardly apart and then spring back into the original form, wherein the fixation grooves 9 engage in the fixation portions 8 of the holding plates 4 when the pipe clip 5 springs back into the original form thereof. For this, the end portions of the pipe clips 5 can be wedge-shaped, such that the bending forces required for expanding the pipe clip 5 can be obtained by the pressure exercised from above on the pipe clip 5 via the wedge-shaped portions. Upon arrival at the guide grooves 9 the fixation portions 8 then slide into the fixation grooves 9.

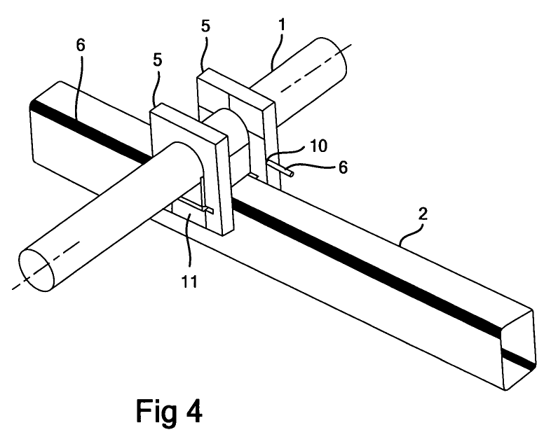

As shown in FIG. 4, the pipe clips 5 can be connected to the pipe hanger 3 by means of a locking pin 6 for the permanent fixation of the tube 1 on the holding beam 2, whereby a detachment or sliding away of the pipe clips 5 from the fixation portions 8 of the holding plates 4 is avoided. For this, locking pin receivers 10 are provided in the pipe clips 5 according to the invention, through which receivers a locking pin 6 can be inserted into the pipe hanger 3. Herein, the locking pin 6 can be made of stainless steel or can for example also have the form of a plastic screw that is screwed into the pipe hanger 3 through the locking pin receiver 10. The design of the tube fixation according to the invention enables this simple manner of fixation since the locking pin 6 is not submitted to any tension loads and therefore this one presents no corresponding material requirements. If the locking pin is furthermore formed as a plastic screw, a corresponding corrosion resistance is also assured.

In another embodiment of the invention the pipe clips 5 can be welded to the pipe hanger 3 for fixation. In the embodiment according to the invention of the pipe hanger 3 and the pipe clips 5 made of synthetic material, these ones can be safely connected to each other by means of plastic welding.

According to the invention, the mounting of a bottom close 11 beneath the holding plate 4 and between the legs of the pipe clip 5 can be furthermore provided in order to assure an additional fixation or an increase of the mechanical stability. Herein, the bottom close 11 can be fixed by means of appropriate locking pins 6, like the pipe hanger 3, or be welded to the pipe clip 5.

What is claimed is:

1. A device for fixing a tube (1) on a holding beam (2), comprising a pipe hanger (3), a holding plate (4) as well as a pipe clip (5), wherein the holding plate (4) is connected to the holding beam (2) and the pipe hanger (3) comprises lateral guide elements (7) that are formed such that the pipe hanger (3) engages in a precisely fitting way into the holding plate (4) connected to the holding beam (2), wherein the holding plate (4) comprises fixation portions (8) projecting over the pipe hanger (3), which fixation portions (8) can engage in fixation grooves (9) in the pipe clip (5) for fastening the tube (1), and wherein the pipe clip (5), in the fixation state, embraces both the tube (1) and the pipe hanger (3) in a precisely fitting way and can be firmly connected to the pipe hanger via fixation means.

2. A device according to claim 1, wherein a locking pin (6) serves as fixation means for connecting the pipe clip (5) to the pipe hanger (3), which locking pin can be inserted into the pipe hanger (3) via a locking pin receiver (10) in the pipe clip (5).

3. A device according to claim 1, wherein a weld between the pipe clip (5) and the pipe hanger (3) serves as fixation means for connecting the pipe clip (5) to the pipe hanger (3), which weld connects the pipe clip (5) to the pipe hanger (3) in the fastened state.

4. A device according to claim 1, wherein the pipe hanger (3) and the pipe clip (5) are made of a synthetic material, preferably polypropylene or a glass fiber reinforced synthetic material (GFK).

5. A device according to claim 1, wherein the holding plate (4) is fastened to the holding beam (2) by means of a weld.

6. A device according to claim 5, wherein a continuous protection against corrosion is realized over the holding plate (4) and the holding beam (2).
